(19) United States
(12) Patent Application Publication
(10) Pub. No.: US 2010/0210161 A1
(43) Pub. Date: Aug. 19, 2010

(54) RADIATION RESISTANT CLOTHING

(76) Inventor: Steven D. Jensen, South Jordan, UT (US)

Correspondence Address: CAO Group, Inc., 4628 W. Skyhawk Drive, West Jordan, UT, 84084, US

(21) Appl. No.: 12/707,623

(22) Filed: Feb. 17, 2010

Related U.S. Application Data
(60) Provisional application No. 61/207,752, filed on Feb. 17, 2009.

(51) Int. Cl. B32B 5/02; B05D 5/00

(52) U.S. Cl. 442/132; 427/160

(57) ABSTRACT

Disclosed herein are radiation resistant protective clothing or fibers and methods of producing the same by the process of impregnating radiation opaque elements into the clothing or fibers to produce garments particularly suited for military, dental, and medical workers exposed to X-rays and other sources of radiation.

### CROSS-REFERENCE TO RELATED APPLICATIONS

This application claims the benefit of U.S. Provisional Application Ser. No. 61/207,752, filed Feb. 17, 2009, the disclosure of which is incorporated herein by reference.

### TECHNICAL FIELD OF THE INVENTION

The present invention relates to the field of protective clothing and, more particularly, to the field of radiation resistant protective clothing and methods of making the same, particularly for military personnel and medical and dental workers exposed to X-rays and other electromagnetic radiation.

### BACKGROUND OF THE INVENTION

Protective clothing is a necessary for workers or personnel exposed to hazardous electromagnetic radiation, which is common in many work environments worldwide. Example work environments where workers, patients or other personnel are exposed to such radiation include X-ray technicians at dental offices or medical radiology offices. Other such environments include airport or border crossing screening areas, where technicians use radiation to scan contents of packages and containers. Yet further environments where exposure to radiation is possible include research or similar facilities where production and testing of radiation generating devices occurs. Even further routes of exposure include destructive weapons that release radiation as intentional means of harming individuals.

Manufacturers of radiation producing devices go to great lengths to minimize the dosage and exposure of radiation throughout routine procedures. Notwithstanding such efforts to minimize exposure to harmful electromagnetic radiation, exposure to residual amounts of harmful radiation still occurs. In many cases, manufacturer recommended safety procedures are monotonous or impractical. Such can occur, for example, where a technician operating a particular radiation generating device omits protective steps in order to save time or attempts to avoid what may seem as excessive labor.

In the matter of accidental or unanticipated exposure, an individual often has no means of protection and can often receive a harmful amount of radiation. In general, most individuals do not prepare for such events, even in high-risk environments. It is usually only in the routine use of radiation that protective clothing is employed. For example, a soldier may be at high risk for radiation exposure on a battlefield, yet the soldier is not issued radiation protective clothing, such as lead-lined aprons or suits. This is impractical since the added weight and extra piece of clothing would be a hindrance and it would have to be worn all the time since the soldier would never know when exposure to radiation might strike. Further, a lead apron placed in a backpack would be useless in these cases. A soldier would be more worried about bullet protection since the odds of bullet exposure are generally greater than radiation exposure. Also, radiation exposure is instantaneous. The soldier would not be aware of the exposure until at or after the moment of incidence, in which case the procedure of unpacking and donning radiation resistant clothing would be futile.

In the case of routine incidental exposures, operators typically know they will be exposed to radiation and can take the necessary precautions. In dental offices, for example, the use of X-rays is routinely used as a diagnostic tool. Dental technicians typically perform the task of operating the device throughout the day. In terms of exposure, an individual patient may receive two to four X-ray exposures in a single visit. Therefore the patient is usually covered with a lead lined apron to limit this exposure occurring annually or biannually. Yet this is only minimal exposure compared to the dental technician who may tend to ten or more patients per day, which could result in upwards of forty or more incidental exposures per workday.

Dental technicians are often required by regulation or office policy to wear radiation protective clothing, such as an apron, during every X-ray procedure. In reality, however, dental technicians often choose not to wear radiation protection during X-ray procedures. What is commonly done, instead, is to step out of the room before the technician triggers the X-ray device. This is thought to provide adequate protection against incidental exposure. However, protection to exposure in many such cases amounts to little more than that provided by a wall of thin wood paneling or sheetrock positioned between the technician and the source of the radiation, which is generally considered insufficient to block exposure to radiation.

Other types of electromagnetic radiation are notorious for reflecting off various surfaces in multiple directions. This also creates a problem for technicians who position themselves behind a wall; the very exposure they are attempting to avoid is being introduced into other areas by reflection. Also, there are many instances where the dental technician must be exposed along with the patient when their services are needed in the room such as to hold an X-ray film in place for a child or disabled individual.

It is evident that in situations of routine exposure to electromagnetic radiation, protection requires more than a passive acknowledgement of the source to limit exposure. Pressure to save time and avoid what may seem as extra work lulls operators into a passive state with regards to radiation safety. A more human compliant means of radiation protection is therefore in order. Also beneficial is a user-friendlier means of radiation protection for accidental and unanticipated exposures.

Some devices of the prior art use metal wire threads woven into the various fabrics in order to create radiation resistance. Such devices, however, permit gaps between the metal wires and the intertwined fabrics and depend on the integrity of the metal wires to stay intact. As clothing is constantly folded or manipulated, the addition of metal wires to the clothing may, over time, break down leading to an eventual degradation in protection.

What is needed, then, is a means to more advantageously introduce radiation resistance and protection into common clothing customarily worn on a daily basis. Such radiation resistant clothing, such as scrubs for the dental or medical office, that is comfortable to wear, easy to produce, and does not require additional steps to achieve radiation protection would be highly beneficial. Exemplar embodiments of such radiation resistant clothing and methods for making the same are described below.

### SUMMARY OF THE INVENTION

A method of loading a fibrous material with a radiation opaque substance is disclosed, along with an article of fibrous material or clothing treated by the method. In one embodiment, the method comprises the steps of: providing a water-soluble radiation opaque salt; dissolving the radiation opaque salt in water to form a radiation opaque solution; providing a fibrous material; immersing the fibrous material in the solution and allowing the fibrous material to absorb the solution; and fixing the radiation opaque salt into the fibrous material.

### BRIEF DESCRIPTION OF THE DRAWINGS

FIG. 1 provides a series of drawings in caricature form to depict the steps used to treat a fibrous material using the method of the present invention.

### DETAILED DESCRIPTION OF THE INVENTION

In one embodiment, the invention comprises the treatment of common textile fibers with chemical solutions to imbed within these fibers radiation opaque substances for making radiation resistant clothing. Throughout the specification, reference is made to “radiation opaque” substances. Those skilled in the art will recognize the meaning of the term depends on the nature of the radiation being referred. For example, if the radiation being referred is ultraviolet (UV) light, it is principally radiation in this portion of the electromagnetic spectrum to which the “radiation opaque” substance should block; the radiation opaque substance may be transparent to radiation having wavelengths different than the radiation being blocked. By “radiation opaque” is meant that no more than 5% and preferably no more than 3% of the radiation of interest (e.g., X-rays) from the radiation field will pass through the substance.

The invention contemplates use of any radiation opaque element, particularly metals having high atomic numbers. These are generally elements that are in the sixth row of the periodic table, but also generally include the rare earth elements. Particularly advantageous members of the group include bismuth, lead and gold. Other advantageous members include mercury, osmium and platinum. Mercury and osmium are toxic, however, and platinum has limited ability to block X-rays and is expensive. Elements such as gold, platinum, lead, bismuth, iron, tungsten, cobalt, nickel, copper, zinc, calcium, strontium, barium, magnesium, chromium, osmium and similar elements are all considered radiation opaque or resistant elements and considered within the scope of the invention. Thin films of these elements tend to absorb and reradiate electromagnetic radiation rather than permit such to pass through.

Tests have shown that an especially useful element in this regard is bismuth. Bismuth has the atomic number 83 and its compounds are used in cosmetics and medicines. The heavy nucleus of bismuth is ideal for inhibiting radiation and is not radioactive. Bismuth is also commercially available in economical quantities. The most useful form of bismuth is its water-soluble salts or insoluble salts that can become water-soluble through addition of organic solvents, polar solvents or surfactants. It is also possible to use organic solvent soluble salts wherein the radiation opaque salts are dissolved directly into organic solvents instead of water. Also used is organo-metallic compounds wherein the bismuth is chemically combined with an organic ligand for either water-soluble or solvent soluble processes and is imbed or dispersed within the textile. Examples of bismuth salts include but are not limited to: bismuth chloride, bismuth iodide, bismuth bromide, bismuth acetate, bismuth citrate, bismuth nitrate, bismuth phosphate, bismuth potassium tartrate, bismuth sodiumiodide and bismuth neodecanoate.

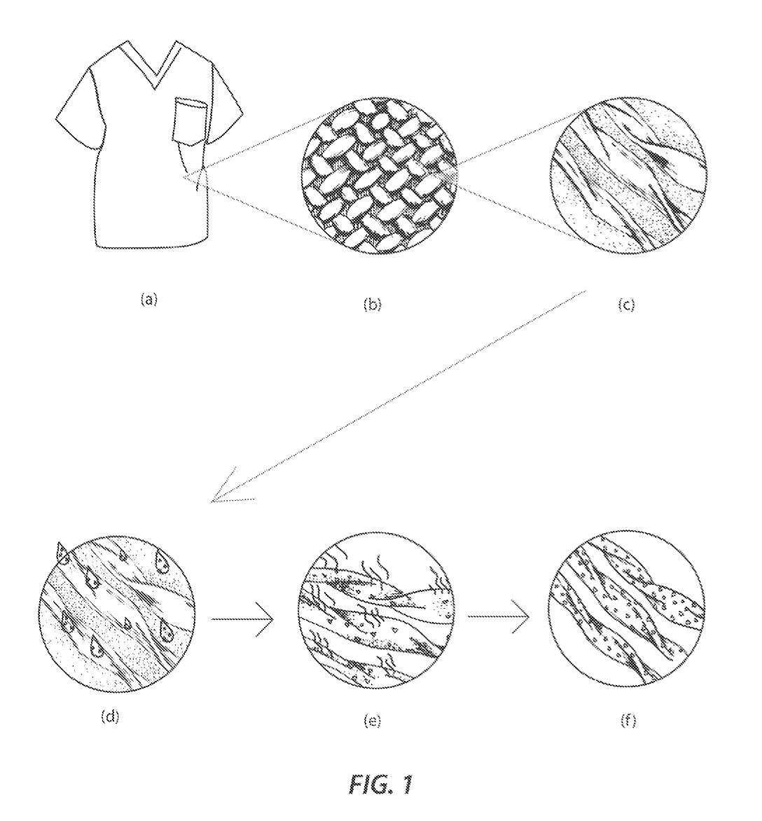

In one embodiment, the chemical process of loading a fibrous material with a radiation opaque salt in an aqueous environment comprises: (i) providing a water-soluble radiation opaque salt; (ii) dissolving the radiation opaque salt in water with or without the aid of solubility modifiers to produce a radiation opaque solution; (iii) adding a fiber treatment surfactant, if desired; (iv) introducing water absorbable fibers as either strands or a completed article of clothing into the solution; (v) allowing the fibers to absorb the soluble radiation opaque salt; (vi) adding a fixation reagent; and (vii) fixing the radiation opaque salt into the fibers by chemical or physical pathways into a water insoluble salt or metallic element. Referring to FIG. 1, certain of the above steps are better described as follows: a fabric material is provided as shown in FIG. 1(a); the fabric material includes a weave of fibrous material as shown in FIG. 1(b), which further includes individual fibers as shown in FIG. 1(c); the fibers are treated with the solution (the solution includes radiation opaque elements or substances as depicted by the black dots in the drops of solution) as shown in FIG. 1(d); the treated fibrous material is then allowed to dry as illustrated in FIG. 1(e); with the result being a fibrous material fixed with a radiation opaque salt as illustrated in FIG. 1(f).

The function of the radiation opaque soluble salt is to allow the radiation opaque element to become soluble in water or organic solvents in order to facilitate its absorption in and throughout the fiber. The function of the fiber treatment surfactant is to provide additional support to the fiber to better allow the penetration of the treatment solutions within the fiber. Examples of fiber treatment surfactants include but are not limited to: sodium lauryl sulfate, polysorbates, lauryl dimethyl amine oxide, cetyltrimethylammonium bromide, polyethoxylated alcohols, polyoxyethylene sorbitan octoxynol, N,N-dimethyldodecylamine-N-oxide, Triton X 100, hexadecyltrimethylammonium bromide, polyoxyl10 lauryl ether, polyoxyl castor oil, nonylphenol ethoxylate, cyclodextrins, lecithin, methylbenzethonium chloride, ethanol, methanol, acetone, propanol, isopropanol, butanol and other useful fiber modification surfactants.

The function of the fixation agents is to fix the radiation opaque element within the fiber by converting the water-soluble salt into an insoluble salt or to the metallic element itself. Fixation can be done by many different methods. One such fixation method is an acid-base method that usually involves replacing a water-soluble halogen anion of a radio opaque element with an insoluble anion with a higher affinity, so that the fixation agent need only be added and mixed into the treatment solution and the thermodynamically favorable conditions exchange the insoluble anion without additional effort. The residual water-soluble halogen anion is then rinsed out of the fiber as a salt.

Another such fixation method involves incorporating a chalcogen or pnictogen onto a soluble radio opaque element by redox and/or acid base reactions. One such method could incorporate a water-soluble oxidizable radio opaque compound into a fiber, when upon drying in ambient air slowly oxidizes to a water-insoluble state. An especially effective fixation method incorporates the use of organometallic radio opaque compounds whose organic components have an affinity for basic compounds such as amines, alkyl amines and polymeric amines. When these organo-metallic compound become soluble a functional amine is added followed by the addition of sulfur. Sulfur has an affinity for bismuth, so in the case of an organometallic bismuth compound, the bismuth is converted to bismuth sulfide and the alkyl group is withdrawn by the amines. This system has the unique properties of completing the fixation upon drying. This is advantageous in that it allows for multiple articles to be put through the same batch of treatment solution without having to change the solution. Examples of fixation agents include but are not limited to: ammonia, 1,4-dioxane, ethyl amine, diethyl amine, butyrolactone, tetrahydrofuran, diethylene glycol mono-ethylether, triethyl amine, triethanol amine, n-cyclohexyl-2-pyrrolidone, n-methyl-2-pyrrolidone, pyridine, benzyl amine, sulfur, oxygen, ozone, selenium, phosphorous and other amines and other insoluble anionic salts.

After fixing the radio opaque element into the fiber it becomes more permanently fixed such that it can withstand additional washings to rinse away any residual unwanted treatment reagents. The completed batch of fibers or articles of clothing that have been fixed must be able to be machine washable by the end user. By creating an insoluble salt the radiation opaque elements resist dissolution from standard household washing machines. A complete fixation of the insoluble radio opaque element into the fiber is vital to aid in decreasing the radiation blocking reduction rate that occurs through repeated washings over the course of time. The fixation of the absorbed soluble salt to an insoluble salt allows for an even diffusion of particles throughout the fiber. This provides an ultra-fine electromagnetic radiation interference matrix, instead of random micro-agglomerates that may not adequately protect a given area. The best results are achieved when the particles are evenly distributed throughout the fiber and the fiber is loaded with as a many particles as it can hold.

The technology of the present invention allows articles of radiation resistant clothing to remain and feel the same as traditional clothing. It allows for an even distribution of radiation resistance throughout the entire fabric of an article of clothing. The clothing of the present invention would feel and bend like common clothing, unlike metal wires in fabric that would resist bending and would feel rigid and stiff. As these radiation resistant textiles are lightweight, they may be sewn into layers of a garment for added protection. This allows more radiation sensitive areas of the body to be additionally shielded through added layers of radiation resistant cloth. Overlapping layers of radiation resistant cloth also blocks radiation passing through the interstices of a single layer of woven fibers.

This technology provides radiation resistance in ordinary clothing that is worn everyday and further provides an advancement over the prior art in that it provides radiation resistance in articles of clothing that do not require adding additional articles or layers of clothing or wearing a stiff metal wire overcoat. This technology is ideal for incidental and unanticipated exposures to radiation because it becomes a part of ordinary clothing that is worn everyday. For example, a soldier's shirt, jacket, socks, pants or any other article of clothing that is normally worn daily would provide constant resistance to any unexpected radiation exposure without any change to their lifestyle to which they are accustomed. The technology of the present invention is also ideal for incidental exposure because it would provide a second level of protection to technicians who omit safety steps and/or stand behind semi-transparent walls during operation of devices that emit radiation.

In a further embodiment, the radiation resistant clothing method comprises: (i) providing a soluble form of a radiation opaque compound or element; (ii) dissolving the radiation opaque compound or element in an appropriate solvent forming a fiber impregnating solution; (iii) soaking an article of clothing or fibers into the resulting impregnating solution such that they absorb the solution; (iv) fixing the absorbed radiation opaque compounds or elements into the clothing fibers by conversion into water insoluble compounds or elements; and (v) rinsing any residual by-products from impregnated fibers or articles of clothing. From this radiation resistant cloth, clothing is developed meeting the needs of a user operating radiation equipment, or emergency or military field needs.

An example of the present invention that has been performed is described as follows. A radio opaque salt comprising fifteen (15) grams of bismuth citrate and a dissolution aid comprising thirty (30) grams of tri-ethanol amine are mixed in a first container with four hundred (400) grams of water until the bismuth completely dissolves and the resulting solution becomes clear. A sulfur catalyst/donator comprising sixteen (16) grams of N-methyl-2-pyrrolidone and a surfactant comprising one (I) gram of Triton-X-100 (available from Dow Chemical) are mixed with ten (10) grams of sulfur in a second container until the solution becomes dark yellowish in color; during mixing, the solution will pass in color from clear, to bluish green and finally to dark yellow. The resulting solutions in the first and second containers are then combined with three hundred eighty four (384) grams of water in a third container and mixed until the resulting solution becomes clear. The entire process is carried out at room temperature. The resulting solution comprises the following components:

### Example #1

| | |
|---|---|
| bismuth citrate | 1.5% |
| tri-ethanol amine | 3.0% |
| sulfur | 1.0% |
| Triton-X | 0.1% |
| N-methyl-2-pyrrolidone | 16.0% |
| water | 78.4% |

In a second example, the sulfur is replaced using twenty (20) grams of sodium thiosulfate and four hundred (400) plus three hundred seventy four (374) grams of water, to produce a solution having the following components:

### Example #2

| | |
|---|---|
| bismuth citrate | 1.5% |
| tri-ethanol amine | 3.0% |
| sodium thiosulfate | 2.0% |
| Triton-X-100 | 0.1% |
| N-methyl-2-pyrrolidone | 16.0% |
| water | 77.4% |

Fibrous clothing is the treated with either of the above described solutions as follows. White dental or medical scrubs made from 100% cotton are immersed in the resulting solution for twelve (12) hours at room temperature, after which the scrubs are removed and wrung of excess solution. The scrubs are then hung to dry for about three (3) days, during which period the scrubs change in color from white to brown. The dried scrubs are then washed in an automatic clothes washing machine with Tide® detergent using hot water for the wash cycle and cold water for the rinse cycle. The final wash and rinse is performed without detergent. The best fibers for use with the present invention include those having the ability to absorb water throughout the entire fiber. Cotton and wool work well in this regard; synthetic fibers, on the other hand, do not absorb water as well as cotton and wool and thus result in less effective treated clothing.

While certain embodiments and details have been included herein and in the attached invention disclosure for purposes of illustrating the invention, it will be apparent to those skilled in the art that various changes in the methods and apparatuses disclosed herein may be made without departing form the scope of the invention, which is defined in the appended claims.

What is claimed is:

1. A method of loading a fibrous material with a radiation opaque substance, comprising the steps of:
providing a water-soluble radiation opaque salt;
dissolving the radiation opaque salt in water to form a radiation opaque solution;
providing a fibrous material;
immersing the fibrous material into said solution;
allowing the fibrous material to absorb the solution; and
fixing the radiation opaque salt into the fibrous material.

2. The method of claim 1, further comprising the step of introducing a radiation opaque substance solubility modifier to the step of dissolving the radiation opaque salt in the water.

3. The method of claim 1, further comprising the step of introducing a surfactant to the step of dissolving the radiation opaque salt in the water.

4. The method of claim 2, wherein the radiation opaque substance solubility modifier is tri-ethanol amine.

5. The method of claim 3, wherein the surfactant is Triton-X.

6. The method of claim 1, wherein the step of fixing comprises the step of converting the water soluble radiation opaque substance into a water insoluble form.

7. The method of claim 1, wherein the step of fixing comprises the step of converting the water soluble radiation opaque substance into a metallic element.

8. A method of loading a fibrous material with a radiation opaque substance, comprising the steps of
providing a quantity of bismuth citrate;
providing a quantity of tri-ethanol amine;
mixing the bismuth citrate and tri-ethanol amine in water to form a soluble radiation opaque solution;
providing a fibrous material;
treating the fibrous material in said solution until the fibrous material absorbs the solution; and
fixing the bismuth citrate into the fibrous material.

9. The method of claim 8, wherein the step of fixing comprises the step of converting the bismuth citrate into the sulfides of bismuth.

10. The method of claim 8, wherein the step of fixing comprises the steps of dissolving a quantity of sulfur in a quantity of N-methyl-2-pyrrolidone and adding the resulting solution to the soluble radiation opaque solution.

11. The method of claim 9, wherein the step of fixing the bismuth citrate into the sulfides of bismuth includes drying the fibrous material.

12. An article of radiation resistant clothing, comprising:
a fibrous material; and
a radiation opaque substance fixed into the fibrous material.

13. The article of radiation resistant clothing of claim 12, wherein the radiation opaque substance is fixed into the fibrous material using the following steps:
providing a quantity of bismuth citrate;
providing a quantity of tri-ethanol amine;
mixing the bismuth citrate and tri-ethanol amine in water to form a soluble radiation opaque solution;
providing the fibrous material;
treating the fibrous material in said solution until the fibrous material absorbs the solution; and
fixing the bismuth citrate into the fibrous material.

14. The article of radiation resistant clothing of claim 13, wherein the step of fixing comprises the step of converting the bismuth citrate into the sulfides of bismuth.

15. The article of radiation resistant clothing of claim 13, wherein the step of fixing comprises the steps of dissolving a quantity of sulfur in a quantity of N-methyl-2-pyrrolidone and adding the resulting solution to the soluble radiation opaque solution.

16. The article of radiation resistant clothing of claim 14, wherein the step of fixing the bismuth citrate into the sulfides of bismuth includes drying the fibrous material.
